(19) United States
(12) Patent Application Publication
(10) Pub. No.: US 2015/0328808 A1
(43) Pub. Date: Nov. 19, 2015

(54) METHOD FOR MANUFACTURING SEAT PAD

(71) Applicant: TOYO TIRE & RUBBER CO., LTD., Osaka (JP)

(72) Inventors: Yu Sasaki, Osaka-shi (JP); Tsuyoshi Yamada, Osaka-shi (JP); Hiroshi Yamada, Osaka-shi (JP)

(73) Assignee: TOYO TIRE & RUBBER CO., LTD., Osaka (JP)

(21) Appl. No.: 14/714,468

(22) Filed: May 18, 2015

(30) Foreign Application Priority Data
May 19, 2014 (JP) 2014-103088

(51) Int. Cl. B29C 44/12; B29D 99/00; B29C 37/00; B29C 44/34; B60N 2/58; B60N 2/64

(52) U.S. Cl. CPC B29C 44/1271; B60N 2/5825; B60N 2/64; B29C 44/1204; B29C 37/0003; B29C 44/34; B29D 99/0092; B29L 2031/58

(57) ABSTRACT

To provide a method for manufacturing a seat pad that can maintain the line speed set in accordance with the speed of foam molding without difficulty. In the state where a molding-surface forming member 30 to be removably mounted on a molding die 20 where a seat pad 3 is foam-molded is removed from the molding die 20, a clipping member 5 (embedded member) is removably secured to the molding-surface forming member 30. Subsequently, the molding-surface forming member 30 to which the clipping member 5 is secured is mounted on the molding die 20. Mounting the molding-surface forming member 30, to which a plurality of the clipping members 5 are secured, on the molding die 20 allows securing the clipping members 5 together to the molding die 20. As a result, it is possible to maintain the line speed set in accordance with the speed of foam molding.

### TECHNICAL FIELD

The present invention relates to a method for manufacturing a seat pad and a molding die, and particularly, relates to a method for manufacturing a seat pad that can maintain a line speed set in accordance with the speed of foam molding without difficulty.

### BACKGROUND ART

Conventionally, there is a technology that holds a part of a seat cover within a groove portion formed on the surface of a seat pad in a suspended state, and mounts the seat cover on the seat pad in the state where the wrinkles caused by the extra length of the seat cover are smoothed. For example, Patent Literature 1 discloses the technology that mounts a linear body such as a wire on a molding die and foam-molds a seat pad, so as to embed the linear body in the groove portion of the seat pad. In this technology, a locking tool disposed on the back surface of the seat cover is locked with respect to the linear body disposed in the groove portion, so as to allow holding a part of the seat cover within the groove portion in a suspended state.

In contrast, there is a technology that mounts a plurality of clipping members on a molding die and foam-molds a seat pad, so as to embed the base portion side of the clipping members in the seat pad. In this technology, a locking tool disposed on the back surface of the seat cover is locked with respect to the clipping members disposed at a plurality of positions in the groove portion, so as to allow holding a part of the seat cover within the groove portion in a suspended state.

There is a seat pad where embedded members, such as felt (nonwoven fabric) and slab material, other than the clipping member and the linear body are embedded in a plurality of positions corresponding to the requirements specification. These embedded members are mounted on a molding die for the seat pad and then embedded in the seat pad by foam-molding the seat pad.

### CITATION LIST

### Patent Literature

[Patent Literature 1] JP-A No. 2011-45424

### SUMMARY OF INVENTION

### Technical Problem

However, the conventional technology described above needs a lot of man-hours to mount the plurality of embedded members on the molding die. Accordingly, in the case of maintaining the line speed set in accordance with the speed of foam molding for the seat pad, a problem has arisen in that it is labor-intensive to mount the embedded members in a short time.

The present invention has been made to address the above problem, and it is an object of the present invention to provide a method for manufacturing a seat pad that can maintain a line speed set in accordance with a speed of foam molding without difficulty.

### [Solution to Problem and Advantageous Effects of Invention]

To achieve this object, with the method for manufacturing the seat pad according to claim 1, the seat pad where the plurality of embedded members are embedded and that is made of foamed synthetic resin is manufactured. Firstly, in the state where the molding-surface forming member to be removably mounted on the molding die where the seat pad is foam-molded is removed from the molding die, the plurality of embedded members are removably secured to the molding-surface forming member in the embedded-member securing step. The molding-surface forming member is the member that forms a part of molding surface. It is possible to eliminate the relationship between: the moving speed (line speed) of the molding die set in accordance with the speed of foam molding; and the speed for securing the embedded members to the molding-surface forming member because the embedded members are secured to the molding-surface forming member in the state removed from the molding die.

Subsequently, the molding-surface forming member to which the plurality of embedded members is secured in the embedded-member securing step is mounted on the molding die in the member mounting step. Mounting the molding-surface forming member to which the plurality of embedded members is secured, on the molding die allows securing the embedded members together to the molding die in a short time. As a result, it is possible to secure the embedded members to the molding die while maintaining the line speed. Subsequently, the seat pad is foam-molded with the molding die where the molding-surface forming member is mounted in the member mounting step, so as to embed the embedded members in the seat pad in the foam molding step. After the seat pad is foam-molded in the foam molding step, simultaneously with demolding or after demolding, the plurality of embedded members embedded in the seat pad is removed from the molding-surface forming member in the removing step. The embedded members are secured to the molding-surface forming member in the state removed from the molding die, and the molding-surface forming member to which the embedded members are secured is mounted on the molding die, so as to allow securing the embedded members together to the molding die. This provides an effect that can maintain the line speed for molding the seat pad without difficulty.

With the method for manufacturing the seat pad according to claim 2, the molding-surface forming member is secured to the molding die by the securing means in the member mounting step. This allows reducing the occurrence of the positional shift of the molding-surface forming member mounted on the molding die during the foam molding step in which the seat pad is foam-molded. This provides an effect that reduces the occurrence of the trouble with the molding surface of the seat pad in addition to the effect according to claim 1 because it is possible to reduce the occurrence of the positional shift of the molding-surface forming member during foam molding.

Here, as the securing means, a permanent magnet and an electromagnet for securing by a magnetic force, a vacuum chuck for securing by a suction force, a clamp metal fitting for securing by a clamping force, and similar member are exemplified.

With the method for manufacturing the seat pad according to claim 3, the securing force of the securing means is varied by the securing-force varying means. After the removing step, in the securing-force reducing step, the securing force of the molding-surface forming member secured to the molding die by the securing means is reduced by the securing-force varying means. This provides an effect that can easily remove the molding-surface forming member from the molding die in addition to the effect according to claim 2.

Here, as the securing-force varying means, an electromagnet that can vary an absorbing force by a magnetic force, a vacuum chuck that can vary a suction force by vacuum, an air cylinder and a hydraulic cylinder that can vary a clamping force, and similar member are exemplified.

With the method for manufacturing the seat pad according to claim 4, the molding-surface forming member is placed on the placing portion of the molding die. The projection portion projects in a protrusion shape along the edge portion of the placing portion, so as to allow the projection portion to abut on the molding-surface forming member in the position distant from the molding surface by the amount of the projection. As the position of the projection portion to abut on the molding-surface forming member becomes more distant from the molding surface, the viscosity of a foamed synthetic resin material (liquid raw material) during foam molding for the seat pad increases. Accordingly, the foamed synthetic resin material becomes less likely to penetrate into the gap between the molding-surface forming member and the projection portion. As a result, this provides an effect that is less likely to cause burrs at the groove portion of the seat pad in addition to the effect according to claim 1.

### BRIEF DESCRIPTION OF DRAWINGS

FIG. 1 is a perspective view of a vehicle seat.

FIG. 2 is a plan view of a seat pad where clipping members are mounted.

FIG. 3 is a cross-sectional view of the seat pad taken along the line III-III in FIG. 2.

FIG. 4 is a side view of the clipping member partially embedded in the seat pad.

FIG. 5 is a plan view of a molding die according to a first embodiment of the present invention.

FIG. 6 is a perspective view of a molding-surface forming member.

FIG. 7 is a cross-sectional view of the molding die taken along the line VII-VII in FIG. 5.

FIG. 8A is a plan view of a clip securing tool, and FIG. 8B is a side view of the clip securing tool.

FIG. 9A is a cross-sectional view of the clip securing tool taken along the line IXa-IXa in FIG. 8A, and FIG. 9B is a cross-sectional view of the clip securing tool taken along the line IXb-IXb in FIG. 8B.

FIG. 10 is a cross-sectional view of the clip securing tool and the clipping member that are fixedly secured to each other.

FIG. 11 is a plan view of a molding die according to a second embodiment.

FIG. 12 is a cross-sectional view of the molding die taken along the line XII-XII in FIG. 11.

FIG. 13A is a plan view of a clip securing tool, FIG. 13B is a side view of the clip securing tool, and FIG. 13C is a cross-sectional view of the clip securing tool taken along the line XIIIc-XIIIc in FIG. 13B.

FIG. 14 is a cross-sectional view of a clipping member.

FIG. 15 is a cross-sectional view of the clip securing tool and the clipping member that are fixedly secured to each other.

FIG. 16 is a cross-sectional view of a molding die according to a third embodiment.

FIG. 17 is a cross-sectional view of a molding die according to a fourth embodiment.

FIG. 18 is a plan view of a molding die according to a fifth embodiment.

FIG. 19 is a cross-sectional view of the molding die taken along the line XIX-XIX in FIG. 18.

FIG. 20 is a plan view of a molding die according to a sixth embodiment.

FIG. 21 is a plan view of a molding-surface forming member viewed in the arrow XXI direction in FIG. 20.

### DESCRIPTION OF EMBODIMENTS

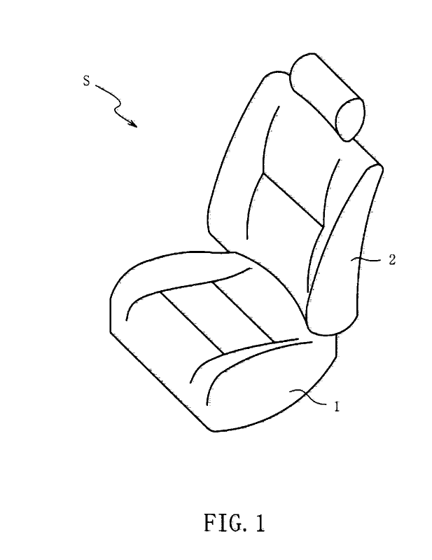

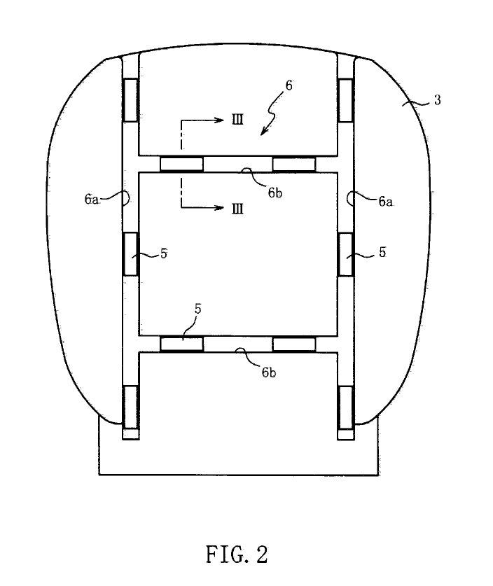

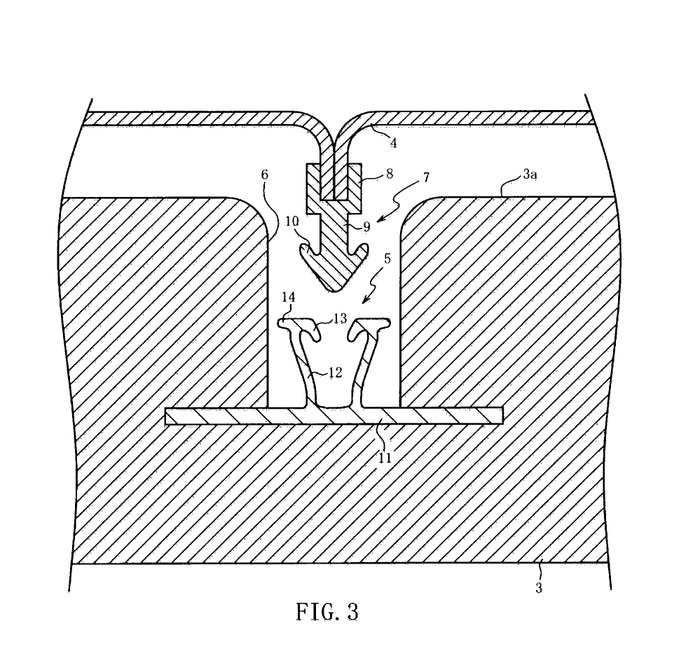

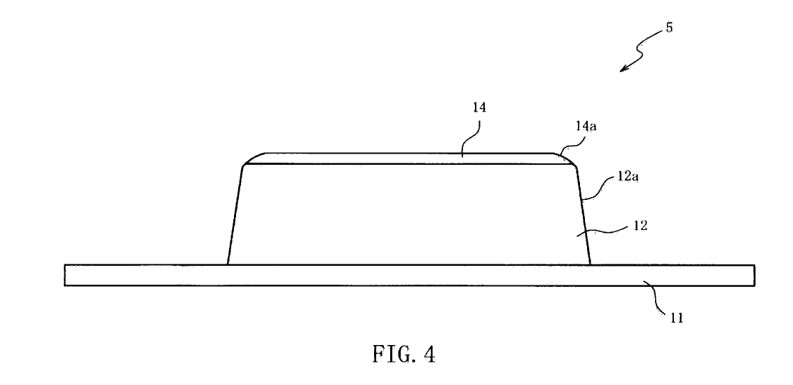

Hereinafter, a description will be given of preferred embodiments of the present invention with reference to the accompanying drawings. FIG. 1 is a perspective view of a vehicle seat S. FIG. 2 is a plan view of a seat pad 3 where clipping members 5 are mounted. FIG. 3 is a cross-sectional view of the seat pad 3 taken along the line III-III in FIG. 2. FIG. 4 is a side view of the clipping member 5 partially embedded in the seat pad 3.

The vehicle seat S illustrated in FIG. 1 includes a cushion pad 1, on which an occupant sits, and a back pad 2, which supports the back of the occupant. The cushion pad 1 includes: the seat pad 3 (see FIG. 3), which is constituted of foamed synthetic resin such as polyurethane foam; a seat cover 4, which covers a mounted surface 3a on the top surface side of the seat pad 3; and the clipping members 5 (see FIG. 2), which mount the seat cover 4 on the seat pad 3. Here, while illustration is omitted, the back pad 2 is constituted almost similarly to the cushion pad 1.

As illustrated in FIG. 2, a groove portion 6 is formed on the mounted surface 3a (see FIG. 3) of the seat pad 3. In this embodiment, the groove portion 6 includes: respective two front-rear-direction groove portions 6a, which extend in the front-rear direction along bank portions at both the right and left sides of the seat pad 3; and respective two right-left-direction groove portions 6b, which extend in the right-left direction. Both ends of the right-left-direction groove portions 6b are communicated with the front-rear-direction groove portions 6a. On the front-rear-direction groove portions 6a and the right-left-direction groove portions 6b, the clipping members 5 (embedded members) are mounted at predetermined intervals from one another along the respective longitudinal directions of the front-rear-direction groove portions 6a and the right-left-direction groove portions 6b (the groove portion 6). Here, the arrangement of the groove portion 6 is not limited to this.

As illustrated in FIG. 3, the groove portion 6 formed on the mounted surface 3a of the seat pad 3 has a predetermined depth. The groove portion 6 is the portion for housing a part of the seat cover 4. At the back surface of the portion along the groove portion 6 in the seat cover 4, a locking tool 7 for pulling in this portion in the groove portion 6 and locking the portion is mounted. The locking tool 7 includes: a coupling portion 8, which is coupled to the seat cover 4 by sewing, adhesion, or similar method; and a hook 9, which extends from the coupling portion 8 to the back surface side of the seat cover 4. At the distal end side of the hook 9, a pair of engaging portions 10, which project out in the mutually opposite directions, are disposed. The engaging portions 10 are formed in a tapered shape whose projection width from the hook 9 increases toward the base end side of the hook 9.

The locking tool 7 continuously extends in the direction approximately parallel to the extending direction of the groove portion 6. That is, the base end side of the hook 9 is formed in a hanging-wall shape extending in the direction approximately parallel to the extending direction of the groove portion 6. The respective engaging portions 10 are continuously formed along the distal end edges of one side surface and the other side surface of the hanging-wall shape.

The clipping member 5 is a member that locks the locking tool 7 to hold a part of the seat cover 4 within the groove portion 6 in a suspended state. The clipping member 5 includes: an embedded portion 11, which is embedded in the seat pad 3; a pair of extending pieces 12 (a part of a locking portion), which protrude from the embedded portion 11 and extend within the groove portion 6; claw portions 13 (a part of the locking portion), which protrude from the respective distal end sides of the pair of the extending pieces 12 in the mutually approaching direction; and guide pieces 14, which protrude from the respective distal end sides of the pair of the extending pieces 12 in the mutually separating direction. These are integrally constituted of elastic synthetic resin or metal.

The embedded portion 11 is a portion for securing the clipping member 5 within the groove portion 6 of the seat pad 3. The embedded portion 11 is formed in an approximately flat plate shape, and includes a plurality of through-holes (not illustrated) formed to pass through the thickness direction. In the embedded portion 11, the formation of the through-holes (not illustrated) causes the foamed synthetic resin, which constitutes the seat pad 3, to get into the through-holes. This provides an anchor effect so as to strongly hold the embedded portion 11 in the seat pad 3.

The extending pieces 12 are a pair of sheet-shaped portions that protrude from one surface side of the embedded portion 11. The extending pieces 12 face each other at a predetermined interval, and are formed to be curved such that the interval between the extending pieces 12 increases at the distal end side than that at the base portion side. The extending piece 12 is constituted to be formed in a thin plate shape so as to be elastically deformable in the mutually approaching and separating directions.

The claw portions 13 are portions for locking the engaging portions 10 of the locking tool 7 disposed at the back surface of the seat cover 4, and are disposed over the longitudinal direction (the vertical direction on the paper in FIG. 3) of the extending pieces 12. The top surface (the surface on the top side in FIG. 3) of the claw portion 13 is inclined downward to be in a lower position (the bottom side of the groove portion 6) toward the distal end of the claw portion 13. The inferior surface (the surface at the embedded portion 11 side) of the claw portion 13 is inclined upward to be in an upper position (to be separated from the embedded portion 11) toward the base portion (the extending piece 12 side) of the claw portion 13.

The guide pieces 14 are portions that function as guides when the engaging portions 10 of the locking tool 7 are inserted between the claw portions 13, and are disposed over the longitudinal direction (the vertical direction on the paper in FIG. 3) of the extending piece 12. The guide pieces 14 protrude from the distal end sides of the mutually facing extending pieces 12 in the separating direction. Disposing the guide piece 14 allows preventing the trouble where, when the locking tool 7 is mounted on the clipping member 5, the hook 9 gets into the space between the extending piece 12 and the inner wall of the groove portion 6 such that the engaging portion 10 and the claw portion 13 cannot be smoothly engaged with each other.

The guide piece 14 has the top surface (the surface on the top side in FIG. 3) formed to be approximately horizontal. The inferior surface (the surface at the embedded portion 11 side) of the guide piece 14 is inclined upward to be in an upper position (to be gradually separated from the embedded portion 11) from the base portion (the extending piece 12 side) toward the distal end of the guide piece 14. As illustrated in FIG. 4, the extending piece 12 and the guide piece 14 of the clipping member 5 include side edges 12a and 14a, which are formed in tapered shapes whose lengths in the longitudinal direction (the right-left direction in FIG. 4) decreases with increasing separation from the embedded portion 11. The protrusion length (projection length) of the guide piece 14 from the extending piece 12 is set to be smaller than the protrusion length (projection length) of the claw portion 13 from the extending piece 12.

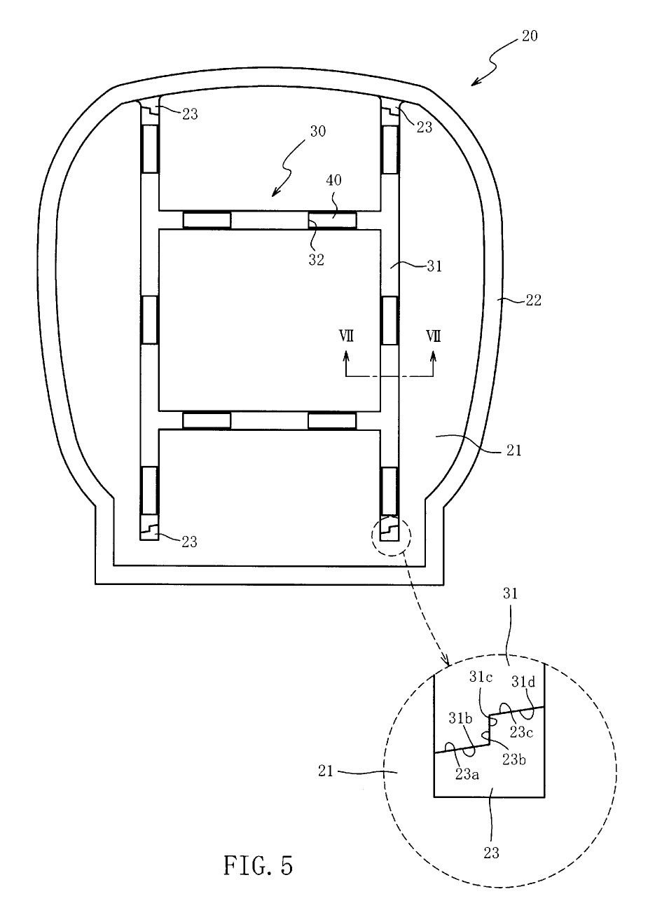

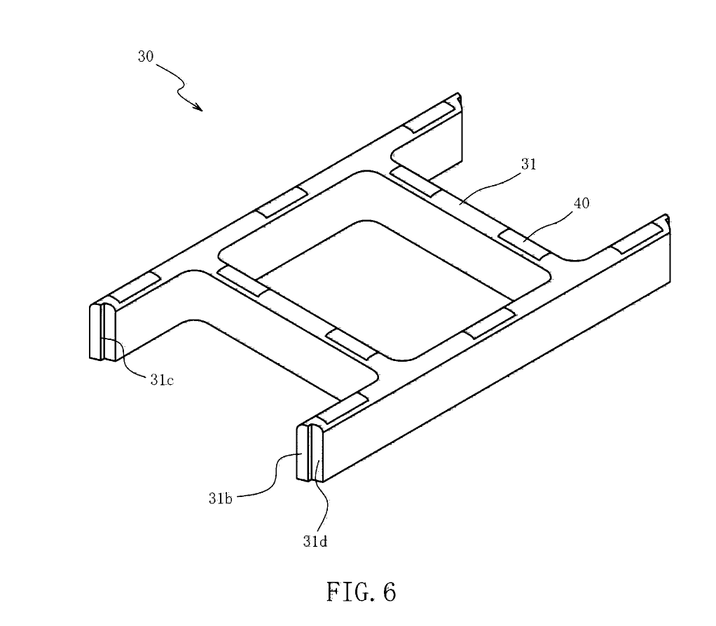

Next, a description will be given of a molding die 20 for foam-molding the seat pad 3 with reference to FIG. 5 and FIG. 6. FIG. 5 is a plan view of the molding die 20 for the seat pad 3 according to a first embodiment of the present invention. FIG. 6 is a perspective view of a molding-surface forming member 30. Here, in FIG. 5, a lower die, on which the mounted surface 3a of the seat pad 3 is formed, is illustrated while the illustration of an upper die, which forms a cavity with the lower die, is omitted in the molding die 20.

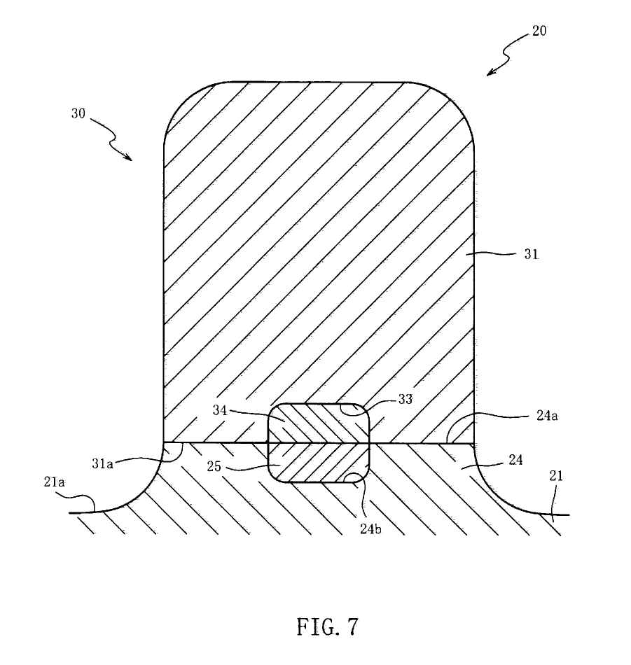

As illustrated in FIG. 5, the molding die 20 is constituted to include: a die bottom portion 21, which constitutes a molding surface 21a (see FIG. 7) for the mounted surface 3a of the seat pad 3; a die wall portion 22, which is disposed upright over the outer peripheral edge of the die bottom portion 21; protruding portions 23, which are disposed upright in protruding shapes in a plurality of positions (four positions in this embodiment) at the die bottom portion 21; and the molding-surface forming member 30, which is positioned by the protruding portions 23. In this embodiment, the molding-surface forming member 30 is a member for molding at least a part of the groove portion 6 of the seat pad 3 in the depth direction.

As illustrated in FIG. 5 and FIG. 6, the molding-surface forming member 30 includes: protrusion portions 31, which are formed in protrusion shapes with respect to the die bottom portion 21 and formed in a ladder shape in plan view; and housing portions 32, which are recessed in a plurality of positions at predetermined intervals in the longitudinal directions of the protrusion portions 31 and house clip securing tools 40. In this embodiment, the molding-surface forming member 30 is made of aluminum, and the protrusion portions 31 are integrally formed. The clip securing tool 40 housed in the housing portion 32 is fixedly secured to the protrusion portion 31 with screws or similar tool.

The following describes the molding-surface forming member 30 with reference to FIG. 7. FIG. 7 is a cross-sectional view of the molding die 20 taken along the line VII-VII in FIG. 5. The molding-surface forming member 30 includes recesses 33 recessed in the bottom portion of the protrusion portion 31. The recesses 33 are formed in a plurality of positions at predetermined intervals in the longitudinal direction (the vertical direction on the paper in FIG. 7) of the protrusion portion 31. To the recess 33, a magnetic member 34 made of magnetic material such as iron is inserted and attached. A bottom surface 31a of the protrusion portion 31 where the magnetic member 34 is inserted and attached to the recess 33 is formed in an approximately planar shape to be flush with the magnetic member 34.

The molding die 20 includes a placing portion 24, which rises from the die bottom portion 21. The placing portion 24 is a portion on which the protrusion portion 31 is placed. The bottom portion of the protrusion portion 31 abuts on the top surface (an abutting surface 24a) of the placing portion 24. In the placing portion 24, the abutting surface 24a as the top end surface of the placing portion 24 is formed in a planar shape to make a close contact with the bottom surface 31a of the protrusion portion 31. The side surface of the placing portion 24 in the short direction (the right-left direction in FIG. 7) is formed in a curved surface shape to be smoothly continuous with the side surface of the protrusion portion 31 in the short direction.

The placing portion 24 includes a hole portion 24b, which is recessed in the position corresponding to the magnetic member 34 inserted and attached to the recess 33 of the protrusion portion 31. The hole portions 24b are formed in a plurality of positions at predetermined intervals in the longitudinal direction (the vertical direction on the paper in FIG. 7) of the placing portion 24, and cores (magnetic cores) 25 of electromagnets are inserted and attached to the hole portions 24b. The core 25 is a ferromagnetic body that attracts the magnetic member 34 disposed at the protrusion portion 31 using a magnetic force, to secure the molding-surface forming member 30 to the placing portion 24. Here, in FIG. 7, the illustrations of the coil wound on the core 25 and similar member are omitted. Turning on the switch (not illustrated) of the electromagnet causes a current flow through the coil to attract the magnetic member 34 to the core 25, so as to secure the molding-surface forming member 30 to the placing portion 24. On the other hand, turning off the switch does not cause a current flow through the coil, so as to remove the magnetic member 34 from the core 25.

Returning to FIG. 5, a description will be given of means for positioning the molding-surface forming member 30 with respect to the die bottom portion 21. The molding die 20 includes the protruding portions 23 disposed upright in protruding shapes in the four positions at the die bottom portion 21. The protruding portion 23 includes a first surface 23a, a second surface 23b, and a third surface 23c, on which the end portions of the protrusion portion 31 in the longitudinal direction of the molding-surface forming member 30 abut. The first surface 23a, the second surface 23b, and the third surface 23c are all surfaces disposed upright in an approximately vertical direction with respect to the die bottom portion 21. The respective first surfaces 23a and third surfaces 23c face one another in the front-rear direction (the up-down direction in FIG. 5) of the molding die 20.

The interval (the distance in the front-rear direction) between the mutually facing first surfaces 23a is set to gradually decrease toward the right side in the right-left direction (the right-left direction in FIG. 5) of the molding die 20. Similarly, the interval (the distance in the front-rear direction) between the mutually facing third surfaces 23c is set to gradually decrease toward the right side in the right-left direction (the right-left direction in FIG. 5) of the molding die 20. Additionally, the interval between the mutually facing third surfaces 23c in the front-rear direction (the up-down direction in FIG. 5) is set to be smaller than the interval between the mutually facing first surfaces 23a in the front-rear direction. The second surface 23b is a surface that is disposed in conjunction with the first surface 23a and the third surface 23c and disposed to extend in the front-rear direction of the molding die 20.

The molding-surface forming member 30 includes first end surfaces 31b, second end surfaces 31c, and third end surfaces 31d, which are formed in the front-rear direction of the protrusion portion 31. The first end surface 31b, the second end surface 31c, and the third end surface 31d of the molding-surface forming member 30 are respective surfaces in close contact with the first surface 23a, the second surface 23b, and the third surface 23c, which protrude at the die bottom portion 21 of the molding die 20.

The first end surface 31b and the third end surface 31d respectively make a close contact with the first surface 23a and the third surface 23c, so as to restrict the movement of the molding-surface forming member 30 in the front-rear direction mainly with respect to the first surface 23a and the third surface 23c. The second end surface 31c makes a close contact with the second surface 23b, so as to restrict the rightward movement of the molding-surface forming member 30 with respect to the second surface 23b. This allows positioning the molding-surface forming member 30 with respect to the die bottom portion 21 of the molding die 20. After the positioning of the molding-surface forming member 30 with respect to the die bottom portion 21 of the molding die 20, turning on the switch (not illustrated) of the electromagnet causes attraction of the magnetic member 34 to the core 25, so as to secure the molding-surface forming member 30 to the placing portion 24.

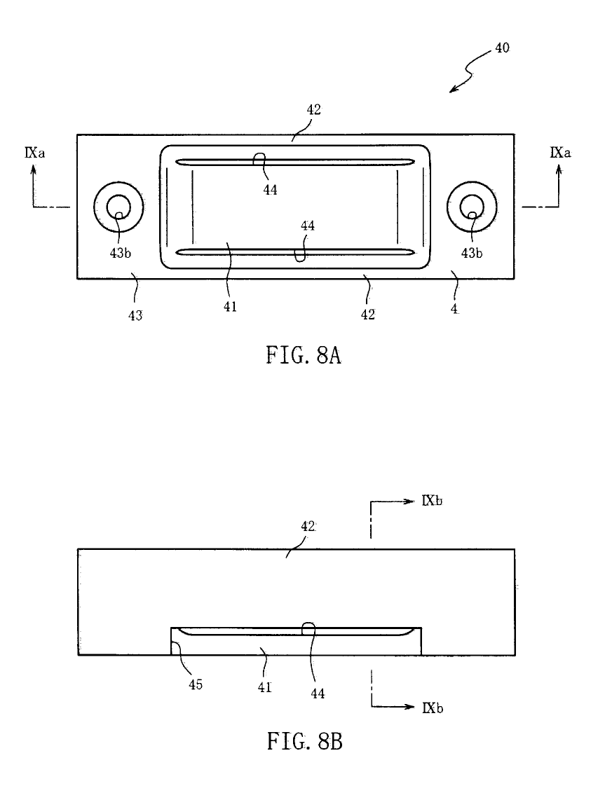

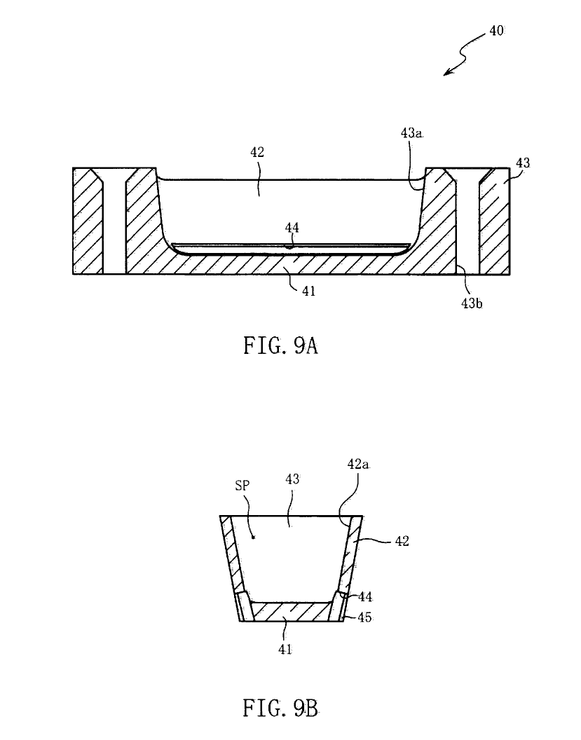

Next, a description will be given of the clip securing tool 40 with reference to FIG. 8 to FIG. 10. Firstly, a description will be given of the configuration of the clip securing tool 40 with reference to FIG. 8 and FIG. 9. FIG. 8A is a plan view of the clip securing tool 40. FIG. 8B is a side view of the clip securing tool 40. FIG. 9A is a cross-sectional view of the clip securing tool taken along the line IXa-IXa in FIG. 8A. FIG. 9B is a cross-sectional view of the clip securing tool 40 taken along the line IXb-IXb in FIG. 8B.

As illustrated in FIG. 8A and FIG. 8B, the clip securing tool 40 is a member formed in an approximately rectangular parallelepiped shape that is horizontally long from a side view. In this embodiment, the clip securing tool 40 is integrally constituted of iron and steel material. As illustrated in FIG. 8A to FIG. 9B, the clip securing tool 40 includes a bottom portion 41 and wall portions 42 and 43, which are disposed upright over the whole circumference of the outer edge of the bottom portion 41. At the bottom portion 41 sides of the wall portions 42 and 43, engaging hole portions 44 are formed.

The bottom portion 41 is a portion for coupling the wall portions 42 and 43 to ensure the mechanical strength of the clip securing tool 40, and is formed in a rectangular board shape in plan view. The wall portions 42 are portions disposed upright at a pair of outer edges at the longer side of the bottom portion 41. Inner wall surfaces 42a (see FIG. 9B) of the wall portions 42 facing each other are inclined to narrow from the upper ends of the wall portions 42 toward the bottom portion 41. The wall portions 42 are portions arranged along the longitudinal direction of the protrusion portion 31 in the case where the clip securing tool 40 is housed in the housing portion 32.

The wall portions 43 are portions disposed upright at a pair of outer edges at the shorter side of the bottom portion 41. Inner wall surfaces 43a (see FIG. 9A) of the wall portions 43 facing each other are inclined to narrow from the upper ends of the wall portions 43 toward the bottom portion 41. The wall portions 43 are formed to be thick-walled compared with the wall portions 42, and include hole portions 43b formed to pass through the wall portions 43 in the thickness direction (the vertical direction on the paper in FIG. 8A). The hole portion 43b has the inner surface where a female screw is threaded. Fastening a flush bolt (not illustrated) screwed on the hole portion 43b to the protrusion portion 31 causes the clip securing tool 40 housed in the housing portion 32 (see FIG. 5) to be fixedly secured to the protrusion portion 31. Surrounding by the wall portions 42 and 43 causes formation of a housing space SP, which houses the extending pieces 12 of the clipping member 5, at the upper side of the bottom portion 41.

The engaging hole portion 44 is an elongated hole formed at the bottom portion 41 side of the wall portions 42 and 43. The engaging hole portions 44 are formed to pass through the wall portions 42 in the thickness direction (the up-down direction in FIG. 8A) over the longitudinal direction (the right-left direction in FIG. 8A) of the wall portions 42, and are cut out from respective both sides of the inner wall surfaces 43a of the wall portions 43 in the width direction toward the thickness direction (the right-left direction in FIG. 8A) of the wall portions 43. As illustrated in FIG. 9B, the upper edge of the engaging hole portion 44 formed to pass through over the inner wall surface 42a and the outer surface of the wall portion 42 is formed to be in an upper position from the outer surface toward the inner wall surface 42a of the wall portion 42. Here, the length (the dimension in the right-left direction in FIG. 8A) of the engaging hole portion 44 is set to be larger than the length (the dimension in the right-left direction in FIG. 4) of the guide piece 14 (see FIG. 4).

A recessed notched portion 45 is a portion where the outer surface side of the wall portion 42 at the bottom portion 41 side is recessed and notched. The recessed notched portion 45 is formed in a rectangular shape that is horizontally long from a side view. The recessed notched portion 45 includes an upper edge that coincides with the upper edge of the engaging hole portion 44, and includes right and left edge portions that are positioned outside both ends of the engaging hole portion 44. Formation of the recessed notched portion 45 allows the wall portion 42 to be thin-walled, so as to allow the engaging hole portion 44 to be easily formed to pass through the wall portion 42.

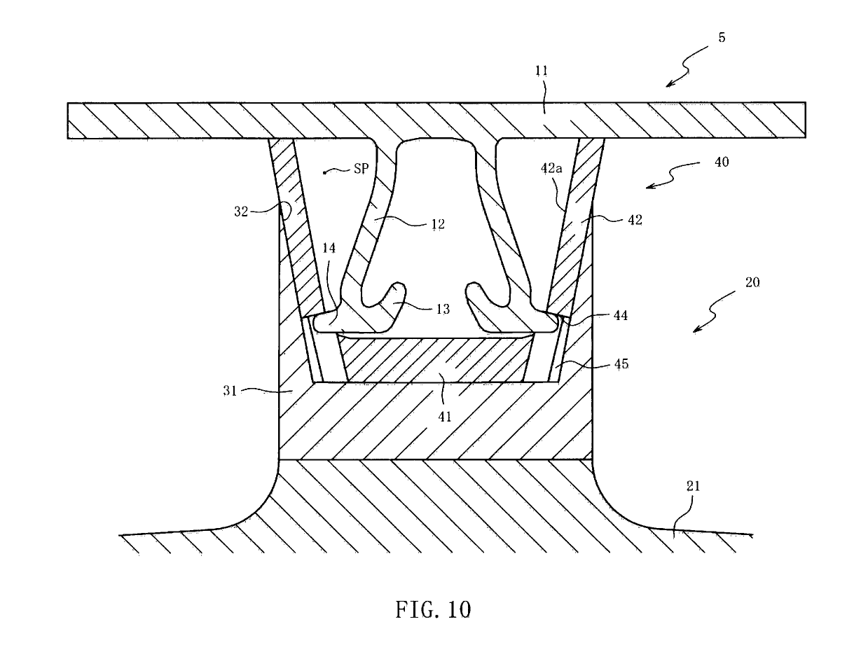

Next, a description will be given of the clip securing tool 40 to which the clipping member 5 is secured with reference to FIG. 10. FIG. 10 is a cross-sectional view of the clip securing tool 40 and the clipping member 5 that are fixedly secured to each other. Here, FIG. 10 is a cross-sectional view in the direction perpendicular to the longitudinal direction of the protrusion portion 31 mounted on the molding die 20 (see FIG. 5). The clip securing tool 40 is housed in the housing portion 32 recessed at the protrusion portion 31 while the bottom portion 41 faces downward. The outer surface at the upper end side of the wall portion 42 of the clip securing tool 40 housed in the housing portion 32 is set to be approximately flush with the side surface of the protrusion portion 31. This is to prevent the protrusion portion 31 from being a large undercut with respect to the wall portion 42 so as to ensure demoldability of the foam-molded seat pad 3.

As illustrated in FIG. 10, in the clip securing tool 40, the interval between the inner wall surface 42a facing each other is set to be wider than the width (the dimension in the right-left direction in FIG. 10) connecting the respective distal ends of the guide pieces 14 at the upper end side of the wall portions 42. Accordingly, when the extending pieces 12 of the clipping member 5 are inserted to the inside of the wall portions 42 and 43, the guide pieces 14 can avoid contact with the inner wall surfaces 42a at the upper end side of the wall portions 42. At the upper end side of the wall portions 43, the interval between the inner wall surfaces 43a (see FIG. 9A) facing each other is set to be larger than the length (the dimension in the right-left direction in FIG. 4) of the extending piece 12 at the distal end side. Furthermore, the inner wall surfaces 42a and 43a facing one another are inclined from the upper ends of the wall portions 42 and 43 toward the bottom portion 41 so as to narrow the respective intervals. This prevents the interference between the clip securing tool 40 and the clipping member 5, so as to facilitate the insertion of the extending pieces 12 of the clipping member 5 to the inside (the housing space SP) of the wall portions 42 and 43.

The interval between the inner wall surfaces 42a is set to be narrower than the width (the dimension in the right-left direction in FIG. 10) connecting the respective distal ends of the guide pieces 14 at the bottom portion 41 side of the wall portion 42. The extending pieces 12 are constituted to be elastically deformable in the mutually approaching direction and separating direction. Accordingly, the distal ends of the guide pieces 14 are pressed against the inner wall surfaces 42a as the guide pieces 14 approach the bottom portion 41, and the extending pieces 12 are elastically deformed in the mutually approaching direction. This restricts the movement of the extending pieces 12 of the clipping member 5 in the facing direction (the right-left direction in FIG. 10) of the inner wall surfaces 42a, so as to allow positioning of the clipping member 5 between the wall portions 42 (in the width direction of the protrusion portion 31 (see FIG. 5)).

At the bottom portion 41 side of the wall portions 43, the interval between the inner wall surfaces 43a (see FIG. 9A) is set to be approximately identical to the lengths of the extending piece 12 and the guide piece 14 at the distal end side. This restricts the movement of the extending pieces 12 of the clipping member 5 in the facing direction (the vertical direction on the paper in FIG. 10) of the inner wall surfaces 43a, so as to allow positioning of the clipping member 5 between the wall portions 43 (in the longitudinal direction of the protrusion portion 31 (see FIG. 5)).

When the guide pieces 14 of the clipping member 5 inserted to the clip securing tool 40 reach the positions of the engaging hole portions 44 formed in the wall portions 42, the extending pieces 12 elastically deformed in the mutually approaching direction are restored in the mutually separating direction such that the guide pieces 14 are inserted into and engaged with the engaging hole portions 44. At this time, the whole circumference of the upper end edges of the wall portions 42 and 43 abuts on the embedded portion 11 of the clipping member 5. As a result, this restricts the movement of the clipping member 5 in the height direction (the up-down direction in FIG. 10) of the clip securing tool 40. Accordingly, this allows positioning of the clipping member 5 in the height direction of the clip securing tool 40.

As described above, simply inserting the extending pieces 12 of the clipping member 5 into the housing space SP of the clip securing tool 40 allows positioning of the clipping member 5 with respect to the clip securing tool 40 in the horizontal direction and the height direction. The work to insert the extending pieces 12 of the clipping member 5 into the housing space SP of the clip securing tool 40 is considerably simple because of the large clearance between the wall portions 42 and 43 and the extending pieces 12. Accordingly, it is possible to improve the work efficiency for securing the clipping member 5 to the molding-surface forming member 30.

Here, the work to secure the clipping member 5 to the molding-surface forming member 30 is performed before the seat pad 3 is foam-molded with the molding die 20 in the state where the molding-surface forming member 30 is removed from the molding die 20. The speed of the step (clipping-member securing step) for securing the clipping member 5 to the molding-surface forming member 30 is slower than the speed of the step (foam molding step) for foam-molding the seat pad 3 with the molding die 20. Accordingly, a large count of the molding-surface forming members 30 to which the clipping member 5 is secured in advance are prepared before foam molding for the seat pad 3. The speed of the step (member mounting step) for mounting the molding-surface forming member 30 to which the clipping member 5 is secured, on the molding die 20 is faster than the speed of foam molding for the seat pad 3. Accordingly, it is only necessary to prepare the molding-surface forming member 30 to which the clipping member 5 is secured, so as to allow maintaining the line speed set in accordance with foam molding for the seat pad 3.

In the case where the clipping member 5 is secured to the molding-surface forming member 30, firstly, in the state where the switch (not illustrated) of the electromagnet is turned off, the molding-surface forming member 30 is positioned with reference to the protruding portion 23 to place the molding-surface forming member 30 on the placing portion 24 of the molding die 20. Subsequently, the switch of the electromagnet is turned on, to attract the magnetic member 34 to the core 25 so as to secure the molding-surface forming member 30 to the placing portion 24. In this state, the seat pad 3 (see FIG. 3) is foam-molded. The clipping member 5 is positioned with respect to the clip securing tool 40 in the horizontal direction and the vertical direction. This allows preventing the clipping member 5 from moving when the foamed synthetic resin material is foamed. As a result, a part (the embedded portion 11) of the clipping member 5 can be embedded in a predetermined position.

The whole circumference of the upper end edges of the wall portions 42 and 43 abuts on the embedded portion 11 of the clipping member 5. Accordingly, this allows preventing a part of a foam-molded body from flowing into the inside of the housing space SP of the clip securing tool 40 when the seat pad 3 is foam-molded. When a part of the foam-molded body flows into the inside of the housing space SP of the clip securing tool 40 and adheres to the extending piece 12 or the claw portion 13, it might become difficult to work (work to mount the seat cover 4 on the seat pad 3) to lock the locking tool 7 disposed at the back surface of the seat cover 4 (see FIG. 3) with respect to the claw portion 13. This can be prevented, so as to ensure the work efficiency for mounting the seat cover 4 on the seat pad 3.

When the seat pad 3 where the clipping member 5 is embedded by foam molding is also demolded from the molding die 20, the switch of the electromagnet is maintained turned on, so as to maintain the state where the molding-surface forming member 30 is attracted to the placing portion 24. This is to demold the seat pad 3 from the molding die 20 and simultaneously separate the molding-surface forming member 30 (the clip securing tool 40) and the clipping member 5 from each other (removing step).

When the seat pad 3 is demolded from the molding die 20, the clipping member 5 is moved toward the upper side (the top side in FIG. 10) with respect to the clip securing tool 40. Accordingly, the guide pieces 14 engaged with the engaging hole portions 44 turn around the distal ends of the extending pieces 12 as fulcrums while being pressed by the upper edges of the engaging hole portions 44 to be elastically deformed. As a result, the guide pieces 14 are disengaged from the engaging hole portions 44 so as to separate the clip securing tool 40 and the clipping member 5 from each other.

Here, the upper edge of the engaging hole portion 44, which is formed to pass through over the inner wall surface 42a and the outer surface of the wall portion 42, is inclined to be in an upper position from the outer surface toward the inner wall surface 42a of the wall portion 42. This allows disengaging the guide piece 14 engaged with the engaging hole portion 44 using a relatively small force. As a result, this prevents the seat pad 3 from being broken in the portion where the clipping member 5 is embedded.

Furthermore, the guide piece 14 includes the inferior surface (the surface at the embedded portion 11 side) inclined to be gradually separated from the embedded portion 11 from the base portion (the extending piece 12 side) toward the distal end of the guide piece 14. Accordingly, when the clipping member 5 is moved toward the upper side (the top side in FIG. 10) with respect to the clip securing tool 40, it is possible to easily disengage the guide piece 14 engaged with the engaging hole portion 44.

The protrusion length (projection length) of the guide piece 14 from the extending piece 12 is set to be smaller than the protrusion length (projection length) of the claw portion 13 from the extending piece 12. This allows reducing the turning amount of the guide piece 14 around the distal end of the extending piece 12 when the guide piece 14 is disengaged from the engaging hole portion 44 compared with the case where the protrusion length of the guide piece 14 is larger than the protrusion length of the claw portion 13. This allows easily disengaging the guide piece 14 from the engaging hole portion 44 when the foam-molded seat pad 3 is demolded from the molding die 20.

After the clipping member 5 is disengaged from the clip securing tool 40 simultaneously with demolding of the seat pad 3, the switch of the electromagnet is turned off, so as to release the attraction of the magnetic member 34 embedded in the molding-surface forming member 30 by the core 25 embedded in the placing portion 24 (securing-force reducing step). This allows removing the molding-surface forming member 30 from the placing portion 24 with a small force (removing step). To the molding-surface forming member 30 removed from the placing portion 24, the clipping member 5 is secured again (clipping-member securing step), and the molding-surface forming member 30 is repeatedly used for foam-molding the seat pad 3.

Here, on the inner wall surface of the groove portion 6 of the foam-molded seat pad 3, the line corresponding to the boundary where the bottom surface 31a of the protrusion portion 31 is in contact with the abutting surface 24a of the placing portion 24 is formed over the longitudinal direction of the groove portion 6. However, this line is fine recesses and protrusions, and does not affect the quality of the seat pad 3.

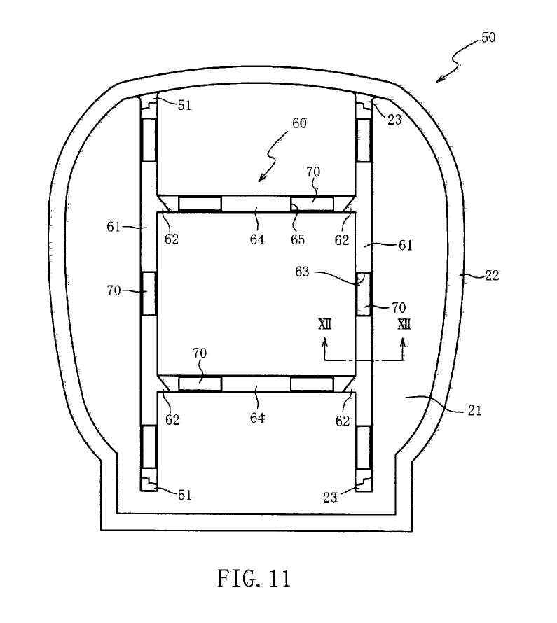

Next, a description will be given of a second embodiment with reference to FIG. 11 to FIG. 15. In the first embodiment, a description has been given of the case where the molding-surface forming member 30 is integrally formed in a ladder shape. In contrast, in the second embodiment, a description will be given of the case where a molding-surface forming member 60 is constituted to be divided. Here, like reference numerals designate corresponding or identical elements in the first embodiment and the second embodiment, and therefore such elements will not be further elaborated. FIG. 11 is a plan view of a molding die 50 according to the second embodiment.

As illustrated in FIG. 11, the molding die 50 is constituted to include: protruding portions 23 and 51, which are disposed upright in protruding shapes in a plurality of positions (four positions in this embodiment) at the die bottom portion 21; and the molding-surface forming member 60, which is positioned by the protruding portions 23 and 51. The molding-surface forming member 60 includes: a pair of longitudinal protrusion portions 61, whose both end portions in the longitudinal direction are engaged with the respective protruding portions 23 and 51 to be positioned; protruded portions 62, which are protruded from two positions on the side surfaces of one longitudinal protrusion portion 61 in the short direction (the right-left direction in FIG. 11) toward the other longitudinal protrusion portion 61; and a pair of lateral protrusion portions 64, whose both end portions in the longitudinal direction are engaged with the respective protruded portions 62 to be positioned. The molding-surface forming member 60 is formed in a ladder shape as a whole by the combination of the longitudinal protrusion portions 61 and the lateral protrusion portions 64, which are formed in straight lines.

Housing portions 63 and 65, which house clip securing tools 70, are recessed in a plurality of positions at predetermined intervals in the respective longitudinal directions of the longitudinal protrusion portions 61 and the lateral protrusion portions 64. In this embodiment, the molding-surface forming member 60 is made of synthetic resin, and the clip securing tools 70 housed in the housing portions 63 and 65 are fixedly secured to the longitudinal protrusion portions 61 and the lateral protrusion portions 64 with screws or similar tool.

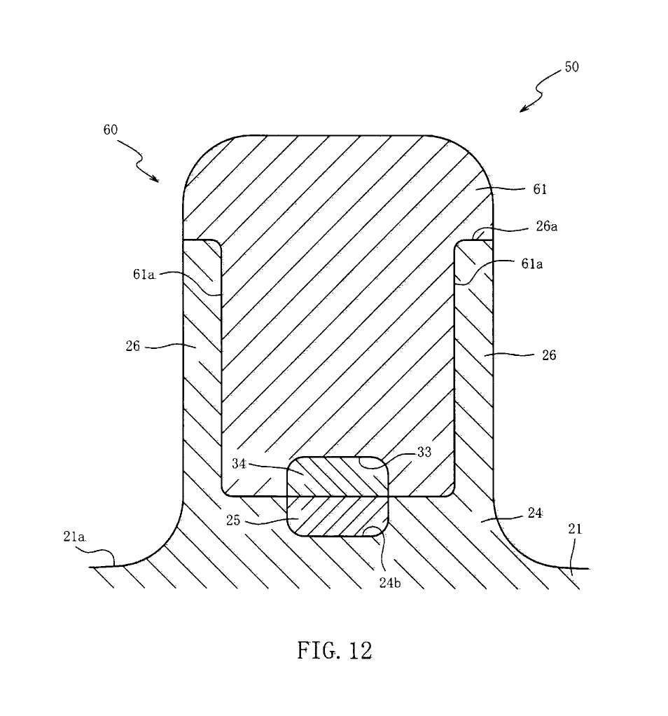

Next, a description will be given of the molding-surface forming member 60 with reference to FIG. 12. FIG. 12 is a cross-sectional view of the molding die 50 taken along the line XII-XII in FIG. 11. Here, the lateral protrusion portion 64 is constituted similarly to the longitudinal protrusion portion 61. Therefore, the longitudinal protrusion portion 61 is described in FIG. 12, and the description of the lateral protrusion portion 64 is omitted.

As illustrated in FIG. 12, the molding die 50 has projection portions 26 at both sides of the placing portion 24, on which the molding-surface forming member 60 is placed, in the short direction (the right-left direction in FIG. 12). The projection portions 26 project in protrusion shapes toward the upper side (the top side in FIG. 12) over the longitudinal direction (the vertical direction on the paper in FIG. 12) of the placing portion 24. On the other hand, on the side surfaces of the longitudinal protrusion portion 61 in the short direction, recessed portions 61a, which receive the projection portions 26, are recessed. When the longitudinal protrusion portion 61 is placed on the placing portion 24, top end surfaces 26a of the projection portions 26 make a close contact with the top end surfaces of the recessed portions 61a, which are recessed in the longitudinal protrusion portion 61. Similarly to the first embodiment, the magnetic member 34 is attracted by the core 25 disposed at the placing portion 24 so as to secure the longitudinal protrusion portion 61 to the placing portion 24.

When the seat pad 3 is foam-molded, after the longitudinal protrusion portion 61 is attracted to the placing portion 24 by the core 25 and the magnetic member 34, a foamed synthetic resin material (liquid raw material) is injected into the molding die 50 (lower die). After the molding die 50 (lower die) is covered by an upper die (not illustrated) so as to close the mold, the foamed synthetic resin material is foamed. As the projection portions 26, both the sides in the short direction project in protrusion shapes over the longitudinal direction of the placing portion 24. This allows the top end surfaces 26a of the projection portions 26 to abut on the molding-surface forming member 60 in the positions distant from the die bottom portion 21 (the molding surface 21a) by the amount of the projection. As the position of the projection portion 26 to abut on the molding-surface forming member 60 becomes more distant from the die bottom portion 21, the viscosity of the foamed synthetic resin material (liquid raw material) during foam molding for the seat pad 3 increases. Accordingly, the foamed synthetic resin material becomes less likely to penetrate into the gap between the recessed portion 61a and the top end surfaces 26a of the projection portions 26. As a result, compared with the molding die 20 according to the first embodiment, burrs are less likely to occur at the groove portion 6 of the seat pad 3.

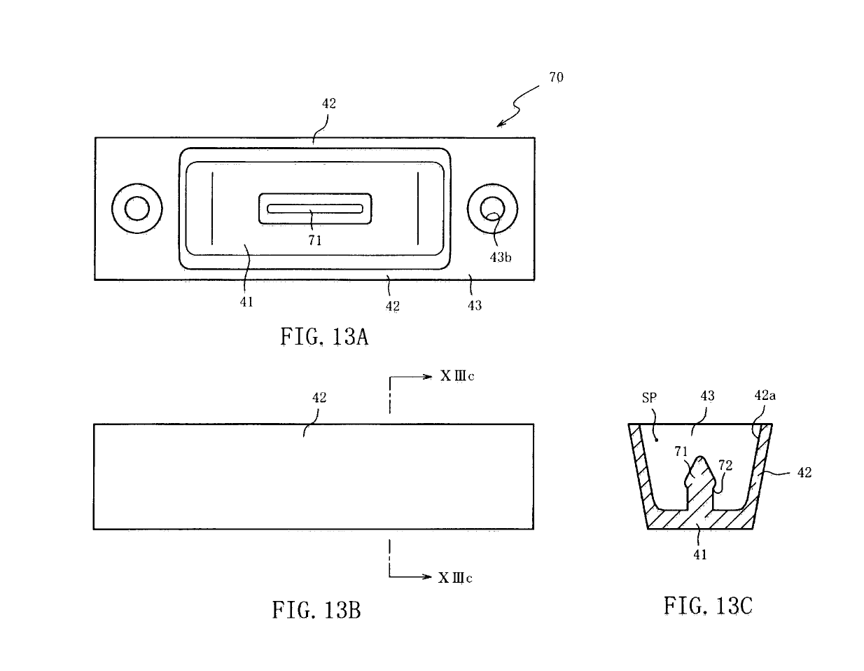

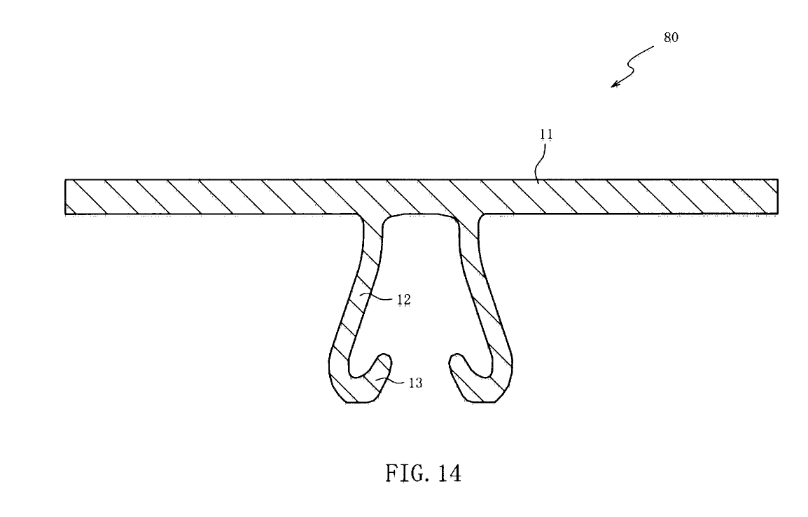

Next, a description will be given of the clip securing tool 70 and a clipping member 80, which are mounted on the molding-surface forming member 60, with reference to FIG. 13 and FIG. 14. FIG. 13A is a plan view of the clip securing tool 70. FIG. 13B is a side view of the clip securing tool 70. FIG. 13C is a cross-sectional view of the clip securing tool 70 taken along the line XIIIc-XIIIc in FIG. 13B. FIG. 14 is a cross-sectional view of the clipping member 80. As illustrated in FIG. 14, the guide pieces 14 (see FIG. 3) are omitted in the clipping member 80, and the configuration of the clipping member 80 is otherwise similar to that of the clipping member 5 described in the first embodiment.

As illustrated in FIG. 13A to FIG. 13C, the clip securing tool 70 is a member formed in an approximately rectangular parallelepiped shape that is horizontally long from a side view. The clip securing tool 70 includes: the bottom portion 41; the wall portions 42 and 43, which are disposed upright over the whole circumference of the outer edge of the bottom portion 41; and an upright portion 71, which is disposed upright on the bottom portion 41. The upright portion 71 is a portion in a protrusion shape disposed upright on the center of the bottom portion 41 to be parallel to the wall portion 42 at predetermined intervals from the wall portions 42 and 43, and is formed in a tapered shape whose thickness in the facing direction to face the wall portions 42 decreases toward the distal end side. In the upright portion 71, engaging recesses 72, which engage with the claw portions 13, are formed on both the side surfaces facing the wall portions 42. The engaging recesses 72 are recessed approximately in the intermediate positions on both the side surfaces of the upright portion 71 in the height direction.

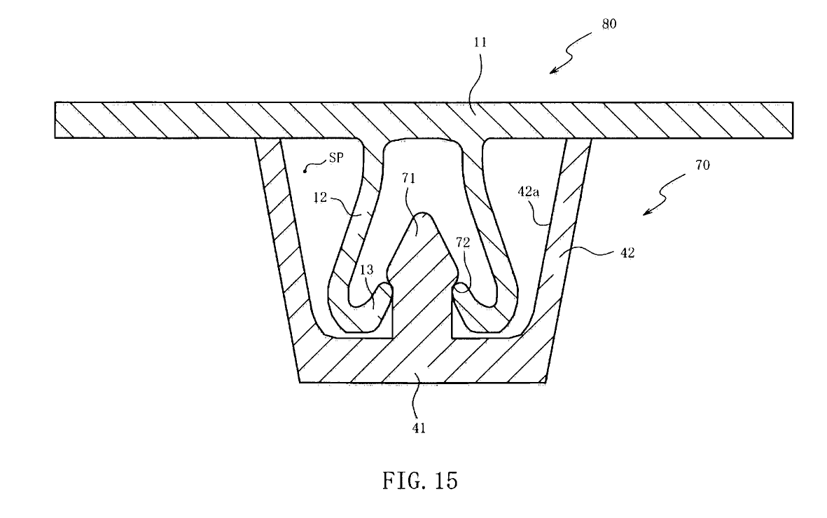

Next, a description will be given of the clip securing tool 70 to which the clipping member 80 is secured, with reference to FIG. 15. FIG. 15 is a cross-sectional view of the clip securing tool 70 and the clipping member 80 that are fixedly secured to each other. Here, the illustration of the molding die to which the clip securing tool 70 is fixedly secured is omitted.

As illustrated in FIG. 15, to secure the clipping member 80 to the clip securing tool 70 mounted on the molding die (not illustrated), the extending pieces 12 of the clipping member 80 are inserted into the housing space SP of the clip securing tool 70. When the extending pieces 12 of the clipping member 80 are inserted into the housing space SP, the upright portion 71 is inserted between the claw portions 13. When the claw portions 13 reach the positions of the engaging recess 72, the claw portions 13 are engaged with the engaging recesses 72 by elastic deformation of the extending pieces 12. At this time, the whole circumference of the upper end edges of the wall portions 42 and 43 abuts on the embedded portion 11 of the clipping member 80. As a result, this restricts the movement of the clipping member 80 in the height direction (the up-down direction in FIG. 15) of the clip securing tool 70.

On the other hand, the movement of the clipping member 80 in the facing direction (the right-left direction in FIG. 15) of the wall portions 42 of the clip securing tool 70 is restricted by interposing the upright portion 71 between the elastically deformable extending pieces 12. Additionally, the movement of the clipping member 80 in the facing direction (the right-left direction in FIG. 13A) of the wall portions 43 of the clip securing tool 70 is restricted by the clearance between: the dimension between the wall portions 43 at the bottom portion 41 side; and the dimension of the extending pieces 12. Accordingly, this allows positioning of the clipping member 80 in the horizontal direction and the height direction of the clip securing tool 70.

As described above, simply inserting the extending pieces 12 of the clipping member 80 into the housing space SP of the clip securing tool 70 allows positioning of the clipping member 80 with respect to the clip securing tool 70 in the horizontal direction and the height direction. The work to insert the extending pieces 12 of the clipping member 80 into the housing space SP of the clip securing tool 70 is considerably simple because of the large clearance between the wall portions 42 and 43 and the extending pieces 12. Accordingly, it is possible to improve the work efficiency for the work to secure the clipping member 80.

The division of the molding-surface forming member 60 into the longitudinal protrusion portions 61 and the lateral protrusion portions 64 allows improving the versatility compared with the molding-surface forming member 30 according to the first embodiment. This is because the molding-surface forming member 60 is constituted of the longitudinal protrusion portions 61 and the lateral protrusion portions 64, and thus different molding-surface forming members can be assembled by the combination of longitudinal protrusion portions and lateral protrusion portions whose shapes, dimensions, counts of the fixedly secured clip securing tools 70, and similar parameter are different from one another.

Here, in the second embodiment, the molding-surface forming member 60 is divided into the longitudinal protrusion portions 61 and the lateral protrusion portions 64. Accordingly, the action to mount the molding-surface forming member 60 on the molding die 50 increases in count compared with the first embodiment. However, it is possible to considerably shorten the time to mount the clipping members 80 on the molding die 50 compared with the case where the clipping members 80 are directly mounted on the molding die 50 before foam molding for the seat pad 3 because the clipping members 80 are mounted on the longitudinal protrusion portions 61 and the lateral protrusion portions 64 in advance. As a result, similarly to the first embodiment, it is possible to maintain the line speed set in accordance with the speed of foam molding without difficulty.

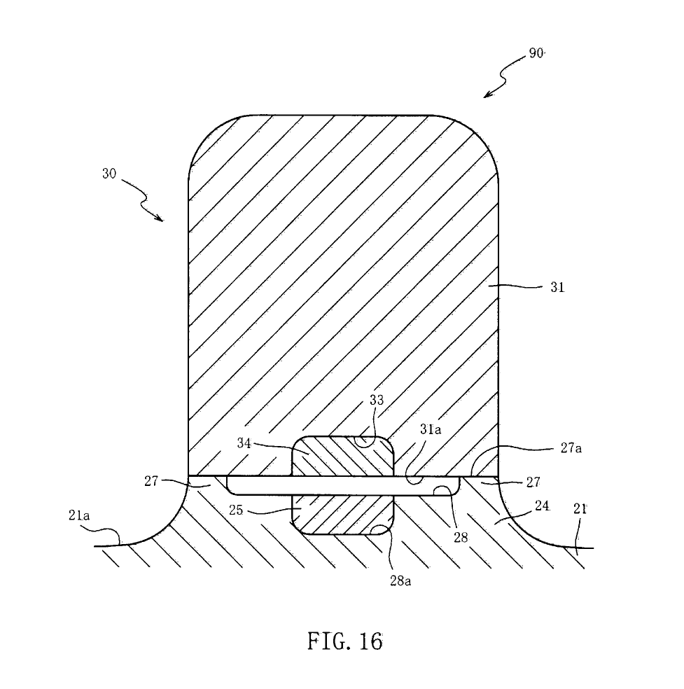

Next, a description will be given of a third embodiment with reference to FIG. 16. In the first embodiment and the second embodiment, a description has been given of the case where the protrusion portion 31 and the longitudinal protrusion portion 61 of the molding-surface forming members 30 and 60 are disposed in close contact with the placing portion 24 over the short direction (the right-left direction in FIG. 7 and FIG. 12). In contrast, in the third embodiment, a description will be given of the case where projection portions 27 protruded at both sides of the placing portion 24 in the short direction (the right-left direction in FIG. 16) abut on the protrusion portion 31 while a gap is disposed between the inner side of the placing portion 24 in the short direction and the protrusion portion 31. Here, like reference numerals designate corresponding or identical elements in the first embodiment and the third embodiment, and therefore such elements will not be further elaborated. FIG. 16 is a cross-sectional view (in the short direction of the protrusion portion 31) of a molding die 90 according to the third embodiment.

As illustrated in FIG. 16, the molding die 90 has the projection portions 27 at both sides of the placing portion 24, on which the molding-surface forming member 30 is placed, in the short direction (the right-left direction in FIG. 16). The projection portions 27 project in protrusion shapes toward the upper side (the top side in FIG. 16) over the longitudinal direction (the vertical direction on the paper in FIG. 16) of the placing portion 24. Between the projection portions 27 at the inner side of the placing portion 24 in the short direction, a recessed groove 28, where the position of the bottom surface is set to be lower than those of the top end surfaces 27a of the projection portion 27, is formed over the longitudinal direction (the vertical direction on the paper in FIG. 16) of the placing portion 24. The recessed groove 28 includes a hole portions 28a, which is recessed in the position corresponding to the magnetic member 34 inserted and attached to the recess 33 of the protrusion portion 31. The hole portions 28a are formed in a plurality of positions at predetermined intervals in the longitudinal direction (the vertical direction on the paper in FIG. 16) of the recessed groove 28, and the cores (magnetic cores) 25 of the electromagnets are inserted and attached to the hole portions 28a.

When the seat pad 3 is foam-molded, after the molding-surface forming member 30 is placed on the placing portion 24, the protrusion portion 31 is attracted to the placing portion 24 by the core 25 and the magnetic member 34. The top end surfaces 27a of the projection portions 27 abut on the bottom surface 31a of the protrusion portion 31 while the gap is formed between the recessed groove 28 and the bottom surface 31a because the projection portions 27 and the recessed groove 28 are formed in the placing portion 24. Subsequently, the foamed synthetic resin material (liquid raw material) is injected into the molding die 90 (lower die). After the molding die 90 (lower die) is covered by an upper die (not illustrated) so as to close the mold, the foamed synthetic resin material is foamed. The contact of the top end surfaces 27a of the projection portions 27 with the bottom surface 31a allows reducing the area in contact with the bottom surface 31a at the placing portion 24 side compared with the first embodiment. As a result, with the identical magnetic force, it is possible to increase the contact pressure acting on the bottom surface 31a by the projection portions 27 compared with the first embodiment. Accordingly, the foamed synthetic resin material becomes less likely to penetrate into the gap between the bottom surface 31a and the top end surfaces 27a of the projection portion 27. As a result, compared with the molding die 20 according to the first embodiment, burrs are less likely to occur at the groove portion 6 of the seat pad 3.

If burrs and similar part having occurred during foam molding are separated from the seat pad 3 and are dropped onto the placing portion 24 as a fragment and then sandwiched between the top end surface 27a of the projection portion 27 and the bottom surface 31a of the protrusion portion 31, the gap occurs between the top end surface 27a and the bottom surface 31a corresponding to the thickness of the fragment. When the foamed synthetic resin material penetrates into the gap, burrs occur in the foam-molded seat pad. In contrast, in this embodiment, the fragment dropped on the placing portion 24 might enter the recessed groove 28 because the recessed groove 28 is recessed in the placing portion 24. Accordingly, compared with the case where the recessed groove 28 is not provided, it is possible to reduce the possibility that the fragment is sandwiched between the top end surface 27a of the projection portion 27 and the bottom surface 31a of the protrusion portion 31. This allows reducing the possibility that burrs are caused by sandwiching the fragment between the top end surface 27a of the projection portion 27 and the bottom surface 31a of the protrusion portion 31.

In the short direction (the right-left direction in FIG. 16) of the placing portion 24, the length (the total length of the right and left projection portions 27) of the projection portions 27 is set to be smaller than the length of the recessed groove 28. That is, the area where the top end surfaces 27a of the projection portion 27 abut on the bottom surface 31a is set to be smaller than the area of the recessed groove 28 in plan view. This ensures a smaller area of the top end surfaces 27a compared with the case where the length (the total length of the right and left projection portions 27) of the projection portions 27 is set to be larger than the length of the recessed groove 28, so as to allow reducing the possibility a fragment is sandwiched between the top end surface 27a and the bottom surface 31a. As a result, burrs are less likely to be caused by sandwiching a fragment between the top end surface 27a of the projection portion 27 and the bottom surface 31a of the protrusion portion 31.

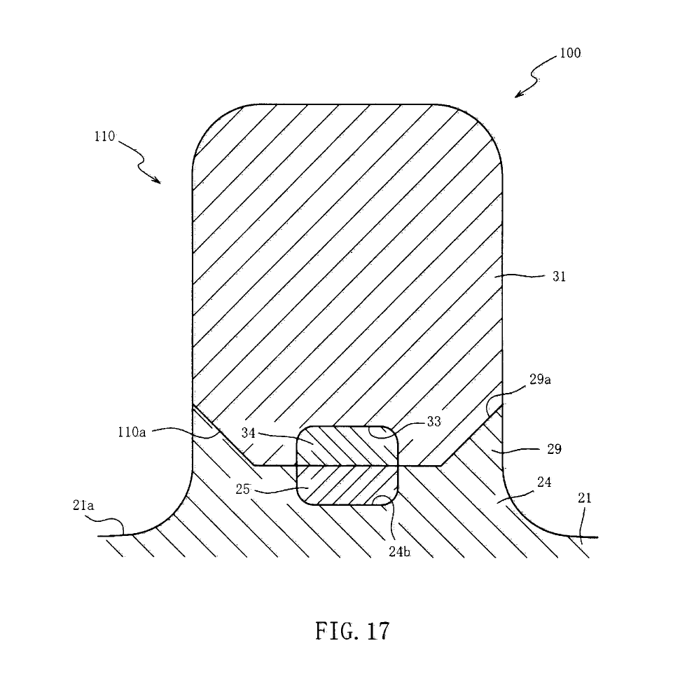

Next, a description will be given of a fourth embodiment with reference to FIG. 17. In the first embodiment, a description has been given of the case where the abutting surface 24a of the placing portion 24 and the bottom surface 31a of the protrusion portion 31 are both formed in a planar shape. In contrast, in the fourth embodiment, a description will be given of the case where a pair of projection portions 29 is protruded at the placing portion 24. Here, like reference numerals designate corresponding or identical elements in the first embodiment and the fourth embodiment, and therefore such elements will not be further elaborated. FIG. 17 is a cross-sectional view (in the short direction of the protrusion portion 31) of a molding die 100 according to the fourth embodiment.

As illustrated in FIG. 17, the molding die 100 includes the pair of projection portions 29 protruded at the placing portion 24. The projection portion 29 has inclined surfaces 29a, which are upwardly inclined toward the outer side of the placing portion 24 in the short direction (the right-left direction in FIG. 17). The projection portions 29 are formed in protrusion shapes over the longitudinal direction (the vertical direction on the paper in FIG. 17) of the placing portion 24. On the other hand, a molding-surface forming member 110 includes inclined surfaces 110a formed in close contact with the inclined surfaces 29a of the projection portion 29. The inclined surfaces 110a are formed as surfaces downwardly inclined from the outer side of the protrusion portion 31 in the short direction toward the inner side in the short direction.

When the seat pad 3 is foam-molded, after the protrusion portion 31 is attracted to the placing portion 24 by the core 25 and the magnetic member 34, a foamed synthetic resin material (liquid raw material) is injected into the molding die 100 (lower die). After the molding die 100 (lower die) is covered by an upper die (not illustrated) so as to close the mold, the foamed synthetic resin material is foamed. The projection portions 29 have the inclined surfaces 29a upwardly inclined toward the outer side of the placing portion 24 in the short direction, and project in protrusion shapes over the longitudinal direction of the placing portion 24. This allows the outer-side edge portions of the projection portions 29 in the short direction to abut on the protrusion portion 31 in the positions distant from the molding surface 21a by the amount of the upward inclination. As the position of the outer-side edge portion of the projection portion 29 in the short direction to abut on the protrusion portion 31 becomes more distant from the molding surface 21a, the viscosity of the foamed synthetic resin material (liquid raw material) during foam molding for the seat pad 3 increases. Accordingly, the foamed synthetic resin material becomes less likely to penetrate into the gap between the inclined surfaces 29a and the inclined surface 110a. As a result, compared with the molding die 20 according to the first embodiment, burrs are less likely to occur at the groove portion 6 of the seat pad 3.

The projection portions 29 have the inclined surfaces 29a formed to be upwardly inclined toward the outer side of the placing portion 24 in the short direction, and the protrusion portion 31 has the inclined surfaces 110a downwardly inclined toward the inner side of the protrusion portion 31 in the short direction. This allows easily mounting the molding-surface forming member 110 in the fixed position within the projection portions 29 of the placing portion 24. This is because the protrusion portion 31 can be guided to the space between the pair of projection portions 29.

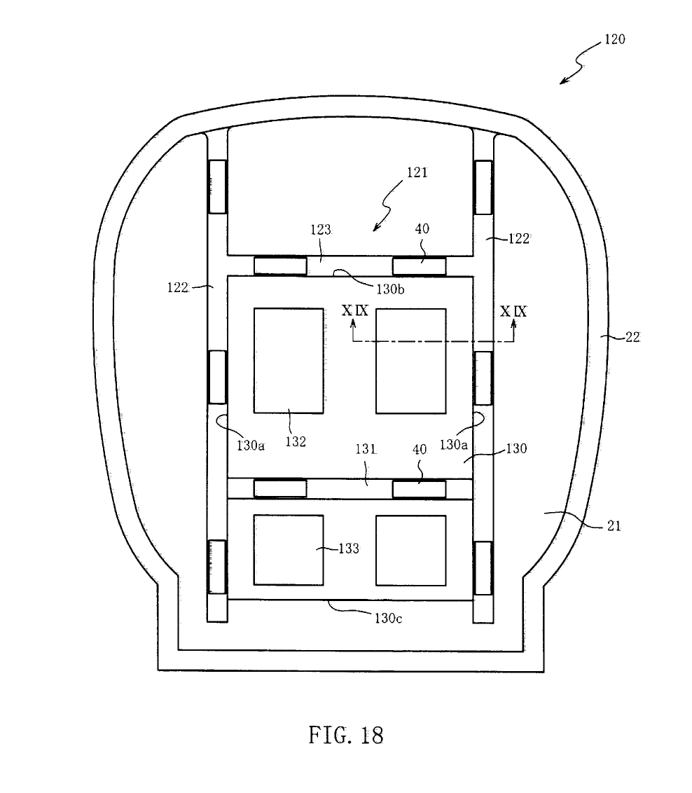

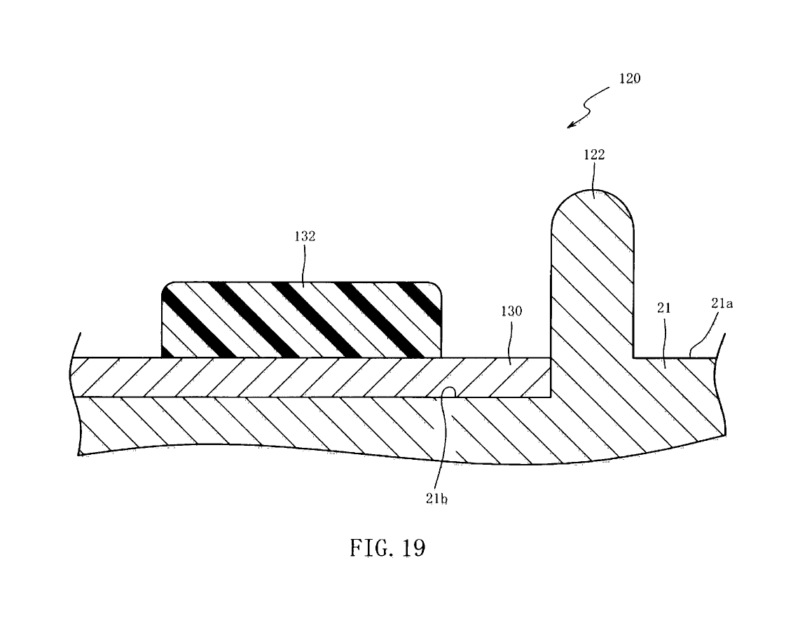

Next, a description will be given of a fifth embodiment with reference to FIG. 18 and FIG. 19. In the first embodiment to the fourth embodiment, a description has been given of the molding-surface forming members 30, 60, and 110 to embed the plurality of clipping members 5 and 80 in the groove portion 6. In contrast, in the fifth embodiment, a description will be given of a molding-surface forming member 130 to embed a plurality of slabs 132 and 133 (embedded members) in the seat pad 3. Here, like reference numerals designate corresponding or identical elements in the first embodiment and the fifth embodiment, and therefore such elements will not be further elaborated.

FIG. 18 is a plan view of a molding die 120 according to the fifth embodiment. FIG. 19 is a cross-sectional view of the molding die 120 taken along the line XIX-XIX in FIG. 18. Here, in FIG. 18, a lower die, on which the mounted surface 3a of the seat pad 3 is formed, is illustrated while the illustration of an upper die, which forms a cavity with the lower die, is omitted in the molding die 120.

As illustrated in FIG. 18, the molding die 120 includes a protrusion portion 121 protruded at the die bottom portion 21. The protrusion portion 121 is a portion for forming the groove portion 6 in the seat pad 3. The protrusion portion 121 includes: two front-rear-direction protrusion portions 122, which extend in the front-rear direction (the up-down direction in FIG. 18) of the die bottom portion 21; and a right-left-direction protrusion portion 123, which extends in the right-left direction (the right-left direction in FIG. 18) and whose both ends are continuous with the front-rear-direction protrusion portions 122. The clip securing tools 40 are mounted at a plurality of respective positions in the front-rear-direction protrusion portions 122 and the right-left-direction protrusion portion 123.

The molding-surface forming member 130 is a member that forms a part of the molding surface of the molding die 120, and the plurality (four in this embodiment) of slabs 132 and 133 embedded in a plurality of positions in the seat pad 3 is removably secured to the molding-surface forming member 130. The slabs 132 and 133 are flexible foams whose compression properties are different from that of the flexible foam constituting the seat pad 3, and are formed in rectangular parallelepiped shapes. In this embodiment, the molding-surface forming member 130 is a plate-shaped member made of aluminum, and is formed integrally with a protrusion portion 131. The protrusion portion 131 is a portion for forming the groove portion 6 in the seat pad 3, and the clip securing tools 40 are mounted on the protrusion portion 131.

In the molding-surface forming member 130, side edges 130a positioned in the right-left direction are disposed in close contact with the inner side surfaces of the two protrusion portions 122, which are protruded at the die bottom portion 21, and an end edge 130b positioned in front is disposed in close contact with the rear side surface of the protrusion portion 123. Additionally, in the molding-surface forming member 130, an end edge 130c positioned in the rear is disposed in close contact with the molding surface 21a of the die bottom portion 21.

As illustrated in FIG. 19, the die bottom portion 21 includes a recessed part 21b (placing portion) recessed at the inner side of the two protrusion portions 122. The molding-surface forming member 130 is mounted on the recessed part 21b while the side edges 130a and the end edge 130b are disposed in close contact with the protrusion portions 122 and 123, so as to form a part of the molding surface of the molding die 120. Here, the molding-surface forming member 130 is removably secured to the recessed part 21b (placing portion) using a magnetic force, a suction force by pressure reduction, or similar force. The slabs 132 and 133 are removably secured to the molding-surface forming member 130 by piercing members (not illustrated) such as needles disposed at the molding-surface forming member 130.

According to the fifth embodiment, in the case where a seat pad is manufactured, firstly, in the state where the molding-surface forming member 130 is removed from the molding die 120, the slabs 132 and 133 are secured to the molding-surface forming member 130 (embedded-member securing step). Subsequently, the molding-surface forming member 130 to which the slabs 132 and 133 are secured is mounted on the molding die 120, so as to form a part of the molding surface 21a by the molding-surface forming member 130 (member mounting step). Mounting the molding-surface forming member 130 on the molding die 120 allows mounting the plurality of slabs 132 and 133 on the molding die 120. Accordingly, it is possible to improve the mounting speed compared with the case where the plurality of slabs 132 and 133 is directly mounted on the molding die 120.

Subsequently, the seat pad 3 is foam-molded with the molding die 120, so as to embed the slabs 132 and 133 in the seat pad 3 (foam molding step). The slabs 132 and 133 are naturally removed from the molding-surface forming member 130 simultaneously with demolding of the foam-molded seat pad 3 (removing step) because the slabs 132 and 133 are integrated with the seat pad 3. After demolding, the molding-surface forming member 130 is removed from the molding die 120, and the slabs 132 and 133 are mounted on the molding-surface forming member 130 separately from the molding line by the molding die 120. It is only necessary to prepare the required count of the molding-surface forming members 130 on which the slabs 132 and 133 are mounted, for the count of the seat pads 3 to be molded in advance so as to allow maintaining the line speed set in accordance with foam molding for the seat pad 3.

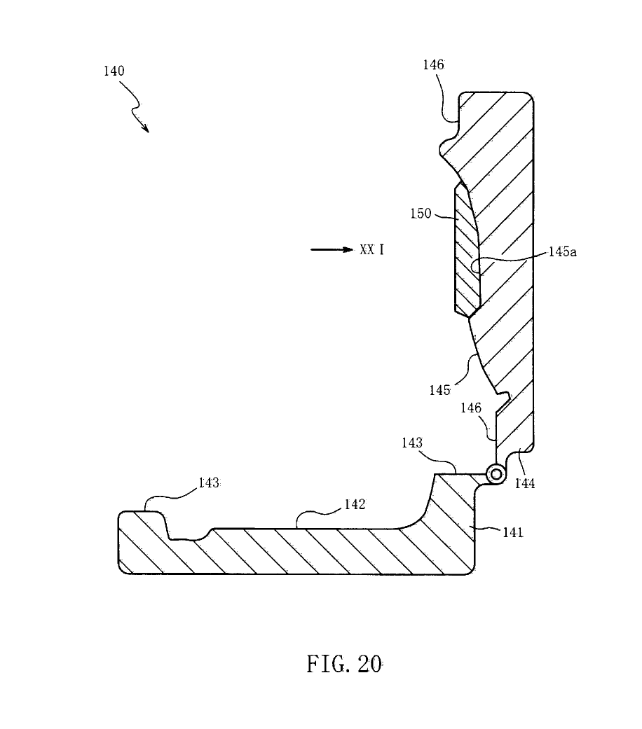

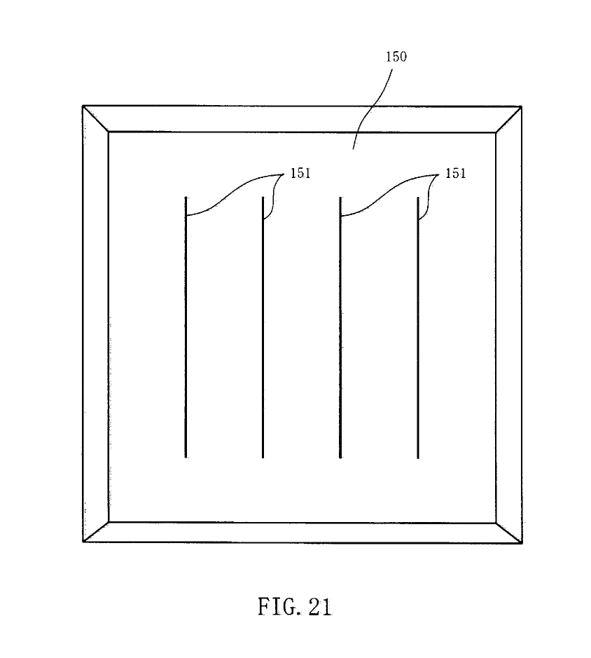

Next, a description will be given of a sixth embodiment with reference to FIG. 20 and FIG. 21. In the first embodiment to the fifth embodiment, a description has been given of the case where the clipping member or the slab (embedded member) is arranged at the lower die (the molding die 20, 50, 90, 100, or 120) where the mounted surface 3a (surface) of the seat pad 3 is formed. In contrast, in the sixth embodiment, a description will be given of the case where wires 151 (embedded members) are arranged at an upper die 144 that forms a cavity with a lower die 141 so as to form the back surface of a seat pad. FIG. 20 is a plan view of a molding die 140 according to the sixth embodiment. FIG. 21 is a plan view of a molding-surface forming member 150 viewed in the arrow XXI direction in FIG. 20. Here, in FIG. 21, the illustration of the upper die 144 present in the peripheral area of the molding-surface forming member 150 is omitted.

As illustrated in FIG. 20, the molding die 140 is constituted to include the lower die 141 and the upper die 144. The lower die 141 is an approximately box-shaped member whose top portion is opened. In the lower die 141, a molding surface 142, which molds the front side of the seat pad 3, is formed and a parting surface 143 is formed at the peripheral edge of the lower die 141. The upper die 144 is a member formed in a lid shape that can seal the molding surface 142 of the lower die 141. At the peripheral edge of a molding surface 145 that molds the back side of the seat pad 3, a parting surface 146 to be a matching surface with the lower die 141 is formed.

The upper die 144 has a placing portion 145a recessed on the molding surface 145. The placing portion 145a is a portion to which the molding-surface forming member 150 is secured. The placing portion 145a secures the molding-surface forming member 150 using a magnetic force or a suction force by pressure reduction or similar method.

As illustrated in FIG. 21, the molding-surface forming member 150 is a plate-shaped member that is formed in a rectangular shape in plan view and made of aluminum, and a plurality of the wires 151 are secured to the molding-surface forming member 150. The wire 151 is removably secured to the molding-surface forming member 150 by a magnet (not illustrated) embedded in the molding-surface forming member 150.

When a seat pad is molded using the molding die 140, firstly, in the state where the upper die 144 is opened with respect to the lower die 141, the molding-surface forming member 150 to which the plurality of wires 151 is secured is mounted on the placing portion 145a formed in the upper die 144. Subsequently, a foamed synthetic resin material (liquid raw material) as the raw material of the seat pad is injected into the molding surface 142 of the lower die 141, and is foamed to be molded after the parting surfaces 143 and 146 are matched to close the mold. After curing for a predetermined time, the mold is opened for demolding the molded seat pad. As a result, the seat pad where the wires 151, which are mounted on the molding-surface forming member 150, are embedded is obtained. Embedding the wires 151 at the back surface side of the seat pad causes adjustment of the rigidity of the seat pad.

With the sixth embodiment, in the state where the molding-surface forming member 150 is removed from the molding die 140, the plurality of wires 151 is secured to the molding-surface forming member 150 and this molding-surface forming member 150 is mounted on the molding die 140, so as to allow mounting the plurality of wires 151 on the molding die 140. Accordingly, it is possible to improve the mounting speed compared with the case where the plurality of wires 151 is directly mounted on the molding die 140. It is only necessary to prepare the required count of the molding-surface forming members 150 on which the wires 151 are mounted, for the count of the seat pads to be molded in advance so as to allow maintaining the line speed set in accordance with foam molding for the seat pad.

As described above, the present invention has been described based on the above-mentioned embodiments. It will be appreciated that the present invention will not be limited to the embodiments described above, but various modifications are possible without departing from the technical scope of the present invention. For example, the shapes described in the above-mentioned embodiments are examples. Other shapes are obviously possible.

In the above-described respective embodiments, a description has been given of the molding dies 20, 50, 90, and 100 for molding the seat pad 3 constituting the cushion pad 1. This should not necessarily be construed in a limiting sense. Application to a molding die for molding a seat pad constituting the back pad 2 is obviously possible.

In the first embodiment to fifth embodiment described above, a description has been given of the case where the clip securing tools 40 and 70 are the members separate from the molding-surface forming members 30 and 60. This should not necessarily be construed in a limiting sense. The clip securing tools 40 and 70 can be obviously formed integrally with the molding-surface forming members 30, 60, and 130. In this case, the molding-surface forming members 30, 60, and 130 formed integrally with the clip securing tools 40 and 70 are preferred to be made of stainless steel to prevent abrasion and rusting due to attachment and removal of the clipping member 5.

Here, the molding-surface forming members 30, 60, 130, and 150 are not limited to be made of aluminum, made of synthetic resin, or made of stainless steel, and can be obviously formed of a rubber-like elastic body or similar material.

In the above-described first embodiment, a description has been given of the case where the bottom portion 41 of the clip securing tool 40 is formed in a board shape. This should not necessarily be construed in a limiting sense. The bottom portion 41 is disposed to be coupled to the wall portions 42 and 43 so as to ensure mechanical strength of the clip securing tool 40. Accordingly, in the case where the mechanical strength may be slightly reduced, the bottom portion 41 can be obviously formed in a ring shape. In the case where the bottom portion 41 is formed in a ring shape, the bottom portion is disposed at the lower ends of the wall portions 42 and 43. In this case, the guide piece 14 can be engaged with the inferior surface of the bottom portion disposed at the lower end of the wall portion 42. It is obviously possible to form the engaging hole portion 44 in the wall portion 42 similarly to the first embodiment, so as to engage the guide piece 14 with the engaging hole portion 44.

In the above-described second embodiment, a description has been given of the clip securing tool 70 where the upright portion 71 in which the engaging recesses 72 are formed is disposed upright on the bottom portion 41. However, this should not necessarily be construed in a limiting sense. It is obviously possible to employ other clip securing tools. The other clip securing tools include, for example, a clip securing tool where engaging hole portions with which the claw portions 13 of the clipping member 80 are engaged are formed in the bottom portion 41. In this case, the engaging hole portions are elongated holes formed at two positions in the bottom portion 41 to be parallel to each other, and are formed to pass through in the thickness direction of the bottom portion 41 while having the longitudinal direction along the wall portion 42.

In the first embodiment to the fourth embodiment described above, a description has been given of the case where the molding-surface forming members 30, 60, and 110 are mounted on the placing portions 24 rising from the molding surfaces 21a of the molding dies 20, 50, 90, and 100. However, the placing portion 24 need not necessarily rise with respect to the molding surface 21a. This is because setting the heights of the molding-surface forming members 30, 60, and 110 as necessary inevitably determines the heights of the placing portions 24 based on the relationship with the depth of the groove portion 6 formed in the seat pad 3.

In the first embodiment to the fourth embodiment described above, a description has been given of the case where the molding-surface forming members 30, 60, and 110 mounted on the placing portions 24 are secured by the suction force of the electromagnet. This should not necessarily be construed in a limiting sense. It is obviously possible to secure the molding-surface forming members 30, 60, and 110 to the placing portions 24 using another securing means. The other securing means may employ various publicly-known means such as: means using a magnetic force by a permanent magnet; means using a suction force by pressure reduction; means using a clamping force by a clamp; and latching onto a latching portion disposed at a molding die.

In the first embodiment to the fourth embodiment described above, a description has been given of the case where the molding-surface forming members 30, 60, and 110 are secured to the placing portions 24 by the suction force of the electromagnet. Accordingly, switching the switch of the electromagnet allows varying the securing forces of the molding-surface forming members 30, 60, and 110 to the placing portion 24. However, means for varying the securing forces of the molding-surface forming members 30, 60, and 110 is not limited to means for attracting the molding-surface forming members 30, 60, and 110 by the electromagnet. For example, in the case where the molding-surface forming members 30, 60, and 110 are secured to the placing portions 24 using the suction force by pressure reduction, varying the magnitude of the pressure allows varying the suction force. In the case where the molding-surface forming members 30, 60, and 110 are secured to the placing portions 24 using the clamping force by a clamp, opening and closing the clamp allows varying the clamping force (securing force).

Here, varying the forces for securing the molding-surface forming members 30, 60, and 110 to the placing portions 24 is not necessarily needed. For example, in the case where the molding-surface forming members 30, 60, and 110 are secured to the placing portions 24 using the magnetic force by a permanent magnet, the magnitude of the magnetic force can be set such that the molding-surface forming members 30, 60, and 110 are secured to the placing portions 24 during foam molding and demolding while the molding-surface forming members 30, 60, and 110 are removed from the placing portions 24 by giving an external force against the magnetic force.

Also, the magnitude of the magnetic force by the permanent magnet can be set such that the molding-surface forming members 30, 60, and 110 are secured to the placing portions 24 during foam molding while the molding-surface forming members 30, 60, and 110 are removed from the placing portions 24 together with the seat pads 3 during demolding. In this case, during demolding, the molding-surface forming members 30, 60, and 110 are removed from the placing portions 24 via the clipping members 5 and 80 embedded in the seat pads 3. Accordingly, after demolding, it is necessary to work to remove the molding-surface forming members 30, 60, and 110 from the seat pads 3. At this time, the molding-surface forming member is preferred to be divided into a plurality of pieces (the molding-surface forming member 60). This is because the molding-surface forming member 60 can be divided so as to be easily removed. Furthermore, the molding-surface forming member 60 divided into a plurality of pieces is preferred to include the longitudinal protrusion portions 61 and the lateral protrusion portions 64 constituted of rubber-like elastic bodies having flexibilities. This is because the flexibilities of the rubber-like elastic bodies can be used to easily remove the longitudinal protrusion portions 61 and the lateral protrusion portions 64 from the seat pad 3.

In the above-described third embodiment, a description has been given of the case where the recessed groove 28 is disposed at the placing portion 24. This should not necessarily be construed in a limiting sense. Instead of disposing the recessed groove 28 at the placing portion 24, it is obviously possible to dispose a recessed groove at the bottom portion of the protrusion portion 31. Also in this case, the recessed groove is less likely to cause a sandwiched fragment such as a burr. In the first embodiment, the second embodiment, and the fourth embodiment, it is obviously possible to dispose a recessed groove in at least one of the molding-surface forming members 30, 60, and 110 and the placing portion 24.

In the above-described respective embodiments, a description has been given of the clipping members 5 and 80, the slabs 132 and 133, the wire 151 as the embedded member embedded in the seat pad 3 as the examples. This should not necessarily be construed in a limiting sense. It is obviously possible to employ other embedded members. The other embedded members include, for example, a nonwoven fabric such as felt, a linear body made of synthetic resin or similar material, and a three-dimensional netted structure that is formed from a plurality of fibers three-dimensionally intertwined together. Here, in the above-described embodiments, a description has been given of the wire 151 (embedded member) embedded at the back surface side of the seat pad 3. Application to a wire (which locks the clipping member) embedded at the front surface side (in the vicinity of the groove portion 6) of the seat pad 3 is obviously possible.

In the above-described embodiments, a description has been given of the case where one type (identical type) of embedded members are secured to the respective molding-surface forming members 30, 60, 110, 130, and 150. This should not necessarily be construed in a limiting sense. Depending on the specification of the seat pad, the molding-surface forming member can obviously have the structure where a plurality of types of embedded members is removably secured.

1. A method for manufacturing a seat pad where a plurality of embedded members is embedded, the seat pad being made of foamed synthetic resin, the method comprising:
an embedded-member securing step of removably securing the plurality of embedded members to a molding-surface forming member in a state where the molding-surface forming member is removed from a molding die, the molding-surface forming member being a member to be removably mounted on a molding die where the seat pad is foam-molded and forming a part of molding surface;
a member mounting step of mounting the molding-surface forming member to which the plurality of embedded members are secured in the embedded-member securing step, on the molding die;
a foam molding step of embedding the embedded members in the seat pad while foam-molding the seat pad with the molding die on which the molding-surface forming member is mounted in the member mounting step; and
a removing step of removing the plurality of embedded members embedded in the seat pad from the molding-surface forming member after the seat pad is foam-molded in the foam molding step, simultaneously with demolding or after demolding.

2. The method for manufacturing the seat pad according to claim 1, wherein
the molding die includes securing means that secures the molding-surface forming member, and
the molding-surface forming member is secured to the molding die by the securing means in the member mounting step.

3. The method for manufacturing the seat pad according to claim 2, wherein
securing-force varying means that varies a securing force of the securing means is provided, the method further comprising
a securing-force reducing step of reducing the securing force of the molding-surface forming member secured to the molding die by the securing means, by the securing-force varying means after the removing step.

4. The method for manufacturing the seat pad according to claim 1, wherein
the molding die includes a placing portion on which the molding-surface forming member is placed, the placing portion including a projection portion that projects in a protrusion shape along an edge portion of the placing portion and abuts on the molding-surface forming member.
